(19) United States
(12) Patent Application Publication
(10) Pub. No.: US 2026/0002383 A1
(43) Pub. Date: Jan. 1, 2026

(54) LIGHTING ARRANGEMENTS FOR DOOR LATCHING AND LOCKING ASSEMBLIES

(71) Applicant: Larson Manufacturing Company of South Dakota, LLC, Brookings, SD (US)

(72) Inventors: Shaun Faust, Medina, OH (US); Daniel Schneider, Fayetteville, AR (US)

(21) Appl. No.: 19/249,276

(22) Filed: Jun. 25, 2025

Related U.S. Application Data
(60) Provisional application No. 63/664,948, filed on Jun. 27, 2024.

(51) Int. Cl. E05B 17/10; F21V 23/04; F21Y 115/10

(52) U.S. Cl. CPC E05B 17/10; F21V 23/0464; F21V 23/0471; F21Y 2115/10

(57) ABSTRACT

A door latching and locking assembly includes an escutcheon plate configured to be mounted to a door, a door handle mounted to the escutcheon plate, a key cylinder mounted to the escutcheon plate, and a lighting arrangement. The lighting arrangement includes a controller in circuit communication with at least one lighting element, a power source, a motion sensor, and an ambient light sensor each carried by the escutcheon plate. The controller is configured to supply power from the power source to the at least one lighting element in response to at least one of an indication from the motion sensor of motion in proximity with the door latching and locking assembly and an indication from the ambient light sensor of ambient light below a predetermined threshold.

### CROSS-REFERENCE TO RELATED APPLICATION

This application claims priority to and all benefit of U.S. Provisional Patent Application Ser. No. 63/664,948, filed Jun. 27, 2024 and entitled LIGHTING ARRANGEMENTS FOR DOOR LATCHING AND LOCKING ASSEMBLIES, the entire disclosure of which is incorporated herein by reference.

### TECHNICAL FIELD

The present invention is directed to lighting arrangements for door latching and lock mechanisms.

### BACKGROUND

Mechanisms for latching and locking closed doors have been developed for the purposes of providing the latching and locking functionality together or independently. In particular, a typical assembly and installation includes mounting an outside door escutcheon plate and an inside escutcheon plate together to one another by way of a lock body that is positioned within a recess or void of a door thickness as such recess is accessible from a door side edge.

Mechanical door latching and locking mechanisms, typically requiring insertion of a bitted key into a key cylinder slot, may be difficult to manipulate in the dark, resulting in inconvenience and/or delays for the user. Conventional entry door lighting arrangements, while providing a lighted condition for door latch manipulation, may provide excessive exterior illumination, resulting in distraction to the building inhabitants, undesirable light pollution, and higher power consumption.

### SUMMARY OF THE DISCLOSURE

In an exemplary embodiment of the present disclosure, a door latching and locking assembly includes an escutcheon plate configured to be mounted to a door, a door handle mounted to the escutcheon plate, a key cylinder mounted to the escutcheon plate, and a lighting arrangement. The lighting arrangement includes at least one lighting element mounted to the escutcheon plate and configured to illuminate at least a portion of the key cylinder, a power source mounted to the escutcheon plate, a motion sensor mounted to the escutcheon plate, an ambient light sensor mounted to the escutcheon plate, and a controller in circuit communication with the lighting element, the power source, the motion sensor and the ambient light sensor. The controller is configured to supply power from the power source to the at least one lighting element in response to at least one of an indication from the motion sensor of motion in proximity with the door latching and locking assembly and an indication from the ambient light sensor of ambient light below a predetermined threshold.

### BRIEF DESCRIPTION OF THE DRAWINGS

Further features and advantages of the invention will become apparent from the following detailed description made with reference to the accompanying drawings, wherein:

FIG. 1 is a perspective view of a latching and locking mechanism for a door;

FIG. 2 is a side view of the latching and locking mechanism of FIG. 1;

FIG. 3 is a perspective view of a lighted latching and locking mechanism assembled with a door;

FIG. 4 is a perspective view of the lighted latching and locking mechanism of FIG. 3; and

FIG. 5 is a schematic view of a lighting arrangement for a lighted door latching and locking mechanism.

### DETAILED DESCRIPTION

This Detailed Description merely describes exemplary embodiments and is not intended to limit the scope of the claims in any way. Indeed, the invention as claimed is broader than and unlimited by the described embodiments, and the terms used have their full ordinary meaning.

The present disclosure contemplates lighting arrangements for adequately illuminating a door latching and locking assembly.

In some implementations, a lighting arrangement is fully contained on or assembled with the door latching and locking assembly.

In some implementations, a direct current power source (e.g., one or more batteries and/or photovoltaic cells) is carried by the door latching and locking assembly.

In some implementations, the lighting arrangement includes an ambient light sensor (ALS) configured to activate at least one lighting element (e.g., LED) of the lighting arrangement when sensed ambient light is below a predetermined threshold (e.g., civil twilight, or about 3 lux).

In some implementations, the lighting arrangement is configured to provide illumination sufficient to be visible at a predetermined darkness condition (e.g., civil twilight) at a desired minimum distance (e.g., about 12 feet).

In some implementations, the lighting arrangement includes a motion sensor (e.g., passive infrared (PIR) sensor) configured to activate at least one lighting element (e.g., LED) of the lighting arrangement when motion is detected near the lighting arrangement.

In some implementations, the lighting arrangement includes a motion sensor (e.g., passive infrared (PIR) sensor) configured to activate at least one lighting element (e.g., LED) of the lighting arrangement when motion is detected at a predetermined minimum distance (e.g., about 12 feet) from the lighting arrangement.

In some implementations, the lighting arrangement includes both an ambient light sensor and a motion sensor, with circuitry configured to activate at least one lighting element (e.g., LED) of the lighting arrangement when (a) sensed ambient light is below a predetermined threshold; and (b) when motion is detected near the lighting arrangement.

In some implementations, the lighting arrangement includes both an ambient light sensor and a motion sensor, with circuitry configured to activate at least one lighting element (e.g., LED) of the lighting arrangement when (a) sensed ambient light is below a predetermined threshold; or (b) when motion is detected near the lighting arrangement.

In some implementations, the lighting arrangement may include a timer to maintain illumination of the at least one lighting element in the absence of motion for a predetermined period (e.g., 5 seconds).

In some implementations, the lighting arrangement may include a timer to limit illumination of the at least one lighting element to a predetermined maximum duration (e.g., 30 seconds).

In some implementations, the lighting arrangement may include a timer to delay re-illumination of the at least one lighting element when the at least one lighting element is deactivated.

In some implementations, at least one lighting element is carried by a door handle of the door latching and locking assembly.

In some implementations, at least one lighting element is carried by a key cylinder of the door latching and locking assembly.

In some implementations, at least one lighting element is mounted to an escutcheon plate of the door latching and locking assembly.

In some implementations, the lighting arrangement includes a light pipe surrounding a key cylinder of the door latching and locking assembly.

In some implementations, the lighting arrangement includes a light pipe surrounding a door handle spindle of the door latching and locking assembly.

In some implementations, the lighting arrangement includes at least one photovoltaic cell carried by an exterior escutcheon plate.

In some implementations, the lighting arrangement includes at least one photovoltaic cell and at least one energy storage element.

In some implementations, the lighting arrangement includes at least one energy storage element connected to at least one photovoltaic cell to supply a charge to the at least one energy storage element.

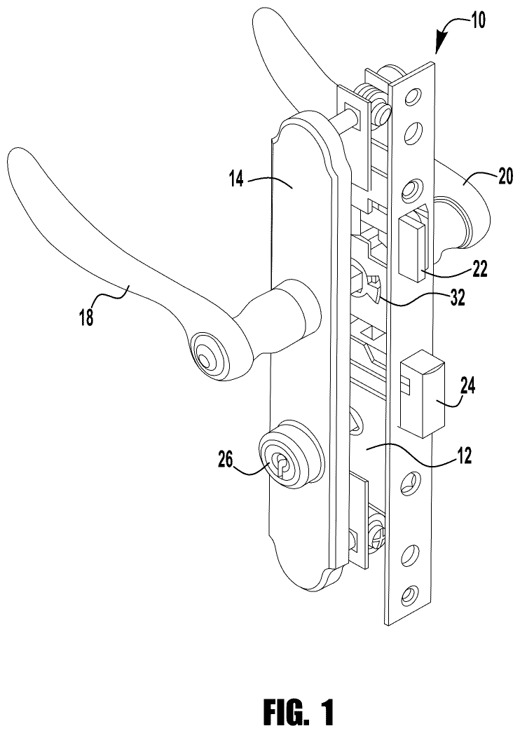

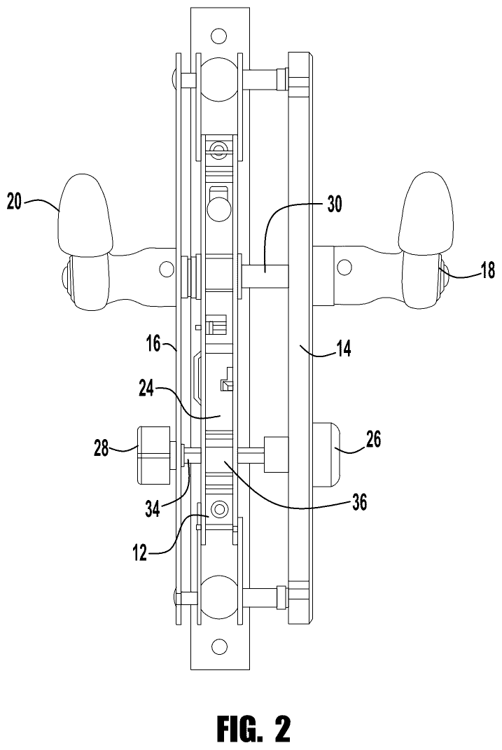

Building doors, such as primary doors and storm doors, may utilize a variety of door latching and locking assemblies. FIGS. 1 and 2 illustrate an exemplary door latching and locking assembly 10 includes a lock body 12 that is operatively connected between an outside escutcheon plate 14 and an inside escutcheon plate 16, which correspondingly surround an outside door handle 18 and an inside door handle 20 and also provide part of the structural connection between the handles 18 and 20 to the lock body assembly 12. Preferably, the outside and insider handles 18 and 20 are operatively connected together so as to turn together and to control the movement of a live bolt 22 for latching and unlatching a door to a strike plate (not shown). The live bolt 22 is operative movably supported within the lock body assembly so as to move linearly in response to rotary movement of the outside and inside handles 18 and 20 as connected to move together.

A dead bolt 24 is also preferably operatively provided for linear movement to and from the lock body 12. As illustrated, the dead bolt 24 can be controlled by a key cylinder 26 on one side of the latching and lock assembly 10, such as supported by the outside escutcheon plate 14, and a thumb knob 28 on the other side of the latching and lock assembly 10, such as supported by the inside escutcheon plate 16. Other arrangements are contemplated as are well known for controlling the dead bolt 24, wherein rotary motion is preferably converted to linear movement of the dead bolt 24 so as to be extendable from or retractable within the lock body 12.

The outside handle 18 is preferably axially fixed to the outside escutcheon plate 14 so as to be rotationally movable. Such a connection can be done by any conventional technique, such as by having a handle shaft as extending from and end of the handle 18 pass through an opening of the escutcheon plate 14 so that the escutcheon plate 14 is positioned between the end of the handle 18 and a snap ring (not shown) or other similar device that is fitted within a groove of the extended handle shaft so as to permit the handle 18 to rotate relative to the escutcheon plate 14. Likewise, the key cylinder 26 of the illustrated embodiment can be similarly rotationally supported as fixed with the outside escutcheon plate 14. The inside handle 20 and thumb knob 28 are preferably similarly rotationally connected and axially fixed with the inside escutcheon plate 16.

Assembly of the outside and inside handles 18 and 20 for rotational movement together can be done in any well-known manner, preferably comprising one of the handles 18 or 20 having a spindle 30 extending from it that is shaped, such as square in cross-section or other non-circular geometries in cross-section, so as to fit within a similarly shaped axial opening of the other extended shaft of the other handle 18 or 20. The spindle 30 preferably also passes through an opening of a live bolt cam 32 that is rotationally supported within the lock body 12 so that rotation of the live bolt cam 32 by action of either handle 18 or 20 as they move together causes extension and retraction of the live bolt 22 from the lock body 12. A similar arrangement can be used for the dead bolt 24 including a shaped deadbolt spindle 34 for controlling deadbolt cam 36 and thus movement of the dead bolt 24.

The exemplary door latching and locking assembly of FIGS. 1 and 2 is described and shown in greater detail in U.S. Patent Application Publication No. 2015/0137536, the entire disclosure of which is incorporated herein by reference.

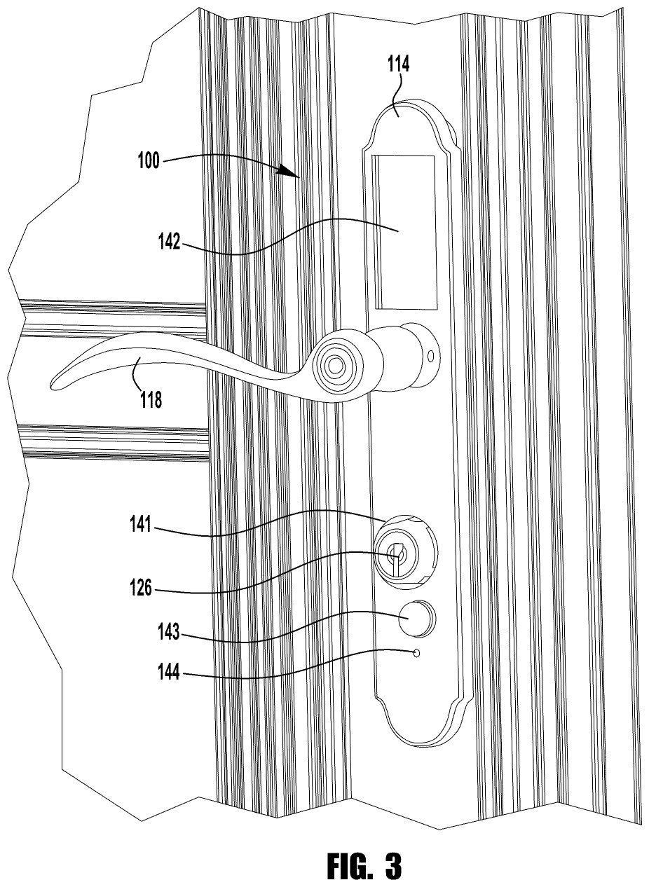

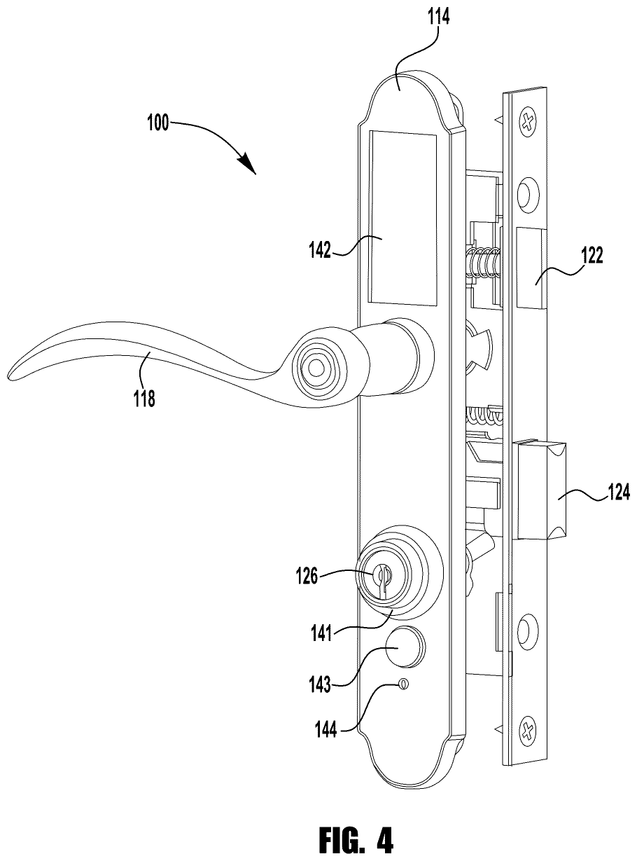

FIGS. 3 and 4 illustrate an exemplary door latching and locking assembly 100 in accordance with exemplary implementations of the present disclosure. As shown, the exemplary assembly 100 includes an exterior escutcheon plate 114 through which a door handle 118 (operable to retract a door latch or live bolt 122) and key cylinder 126 (operable to retract or extend a deadbolt 124) are mounted, which may, but need not, be functionally and/or structurally similar to the similar to the door latching and locking assembly 10 of FIGS. 1 and 2. The escutcheon plate 114 is configured to carry a lighting arrangement. While many different lighting arrangement positions and configurations may be used, for example, to illuminate the key cylinder 126, in the illustrated embodiment, the lighting arrangement includes a light ring 141 installed around the key cylinder and carrying (e.g., on a ring-shaped circuit board) or transmitting (e.g., through a light pipe) light from one or more lighting elements (not shown) in an illuminated ring around the key cylinder. In other embodiments, the lighting elements may be mounted directly to the surface of the escutcheon, key cylinder, or door handle, or to a ring surrounding the door handle stem.

As shown, the escutcheon plate 114 may be configured to carry a solar cell 142 configured to generate power to supply power to the lighting elements. In some configurations, an additional power source (e.g., one or more batteries, capacitors and/or other energy storage element) may be provided to supply additional or alternative power to the lighting element, and/or to store power generated by the solar cell.

As shown, the escutcheon plate 114 may be configured to carry a motion sensor 143 (e.g., passive infrared sensor) electrically connected to the lighting elements (e.g., by a circuit board and controller) to activate the lighting elements in response to sensed motion (e.g., a signal transmitted from the motion sensor to a controller) in proximity (e.g., within about 12 feet) with the door latching and locking assembly 100.

As shown, the escutcheon plate 114 may be configured to carry an ambient light sensor (ALS) 144 electrically connected to the lighting elements (e.g., by a circuit board and controller) to activate the lighting elements in response to sensed ambient light (e.g., a signal transmitted from the motion sensor to a controller) below a predetermined threshold (e.g., civil twilight, or about 3 lux).

In some embodiments, the controller may be configured to activate the lighting elements only in response to both sensed motion in proximity with the door latching and locking assembly and sensed ambient light is below a predetermined threshold.

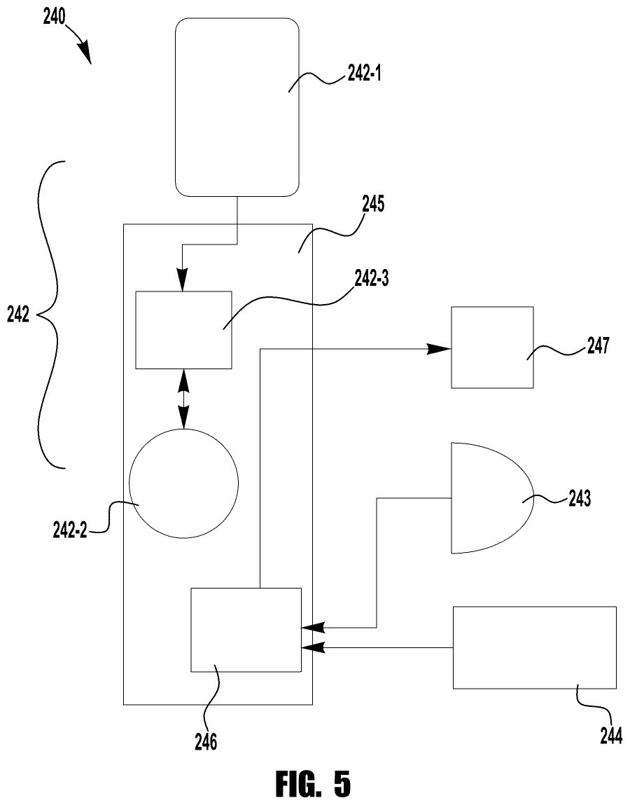

FIG. 5 illustrates a schematic diagram of an exemplary lighting arrangement 240, including a circuit board 245 providing circuit communication between a controller 246 and a lighting element (LED) 247, a motion sensor 243, an ambient light sensor 244, and a power source 242. The exemplary power source includes a photovoltaic or solar cell 242-1 and an energy storage element 242-2 (e.g., one or more batteries or capacitors) providing storage for power generated by the solar cell 242-1 and transmitted to the energy storage element by a charge control circuit 242-3 for storage in the energy storage element, which is in circuit communication with the controller 246.

While various aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value, values within 5% of the specified value, and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A door latching and locking assembly comprising:
an escutcheon plate configured to be mounted to a door;
a door handle mounted to the escutcheon plate;
a key cylinder mounted to the escutcheon plate; and
a lighting arrangement comprising:
at least one lighting element carried by the escutcheon plate and configured to illuminate at least a portion of the key cylinder;
a power source carried by the escutcheon plate;
a motion sensor carried by the escutcheon plate;
an ambient light sensor carried by the escutcheon plate; and
a controller in circuit communication with the lighting element, the power source, the motion sensor and the ambient light sensor;
wherein the controller is configured to supply power from the power source to the at least one lighting element in response to at least one of an indication from the motion sensor of motion in proximity with the door latching and locking assembly and an indication from the ambient light sensor of ambient light below a predetermined threshold.

2. The assembly of claim 1, wherein the lighting arrangement comprises a light transmitting ring installed around the key cylinder.

3. The assembly of claim 1, wherein the power source comprises a direct current power source.

4. The assembly of claim 1, wherein the at least one lighting element comprises a light emitting diode.

5. The assembly of claim 1, wherein the predetermined threshold is about 3 lux.

6. The assembly of claim 1, wherein the lighting arrangement is configured to provide illumination sufficient to be visible at civil twilight darkness conditions at a minimum distance of about 12 feet.

7. The assembly of claim 1, wherein the lighting arrangement includes a timer configured to maintain illumination of the at least one lighting element in the absence of motion for a predetermined period.

8. The assembly of claim 1, wherein the lighting arrangement includes a timer configured to limit illumination of the at least one lighting element to a predetermined maximum duration.

9. The assembly of claim 1, wherein the lighting arrangement includes a timer configured to delay re-illumination of the at least one lighting element when the at least one lighting element is deactivated.

10. The assembly of claim 1, wherein the at least one lighting element is mounted to the door handle.

11. The assembly of claim 1, wherein the at least one lighting element is mounted to the key cylinder.

12. The assembly of claim 1, wherein the at least one lighting element is mounted to the escutcheon plate.

13. The assembly of claim 1, wherein the lighting arrangement includes a light pipe surrounding the key cylinder.

14. The assembly of claim 1, wherein the lighting arrangement includes a light pipe surrounding a spindle of the door handle.

15. The assembly of claim 1, wherein the power source includes at least one photovoltaic cell carried by the escutcheon plate.

16. The assembly of claim 1, wherein the power source includes at least one photovoltaic cell and at least one energy storage element.

17. The assembly of claim 1, wherein the power source includes at least one energy storage element connected to at least one photovoltaic cell to supply a charge to the at least one energy storage element.
